(19) United States
(12) Patent Application Publication
(10) Pub. No.: US 2013/0235352 A1
(43) Pub. Date: Sep. 12, 2013

(54) ILLUMINATION SYSTEM FOR PROJECTION DEVICE

(71) Applicant: DELTA ELECTRONICS, INC., Taoyuan Hsien (TW)

(72) Inventors: Chi-Hsuan HSU, Taoyuan Hsien (TW); Wei Hsiu CHANG, Taoyuan Hsien (TW)

(73) Assignee: DELTA ELECTRONICS, INC., Taoyuan Hsien (TW)

(21) Appl. No.: 13/676,166

(22) Filed: Nov. 14, 2012

(30) Foreign Application Priority Data
Mar. 9, 2012 (TW) 101107987

(51) Int. Cl. G03B 21/14; F21V 9/00

(52) U.S. Cl. CPC G03B 21/14; F21V 9/00
USPC 353/31; 362/231

(57) ABSTRACT

An illumination system for a projection device is provided. The illumination system comprises a light emitting element, a color wheel and at least one actuator. The light emitting element is adapted to generate a first wave band light, while the color wheel has a wheel disk and a plurality of wave band transforming areas formed on the wheel disk. The at least one actuator is connected to the color wheel to move the color wheel to a selected position so that the first wave band light is projected onto one of the wave band transforming areas to excite a plurality of selected wave band lights.

This application claims priority to Taiwan Patent Application No. 101107987 filed on Mar. 9, 2012.

### CROSS-REFERENCES TO RELATED APPLICATIONS

Not applicable.

### BACKGROUND OF THE INVENTION

1. Field of the Invention

The present invention relates to an illumination system for a laser projection device, and more particularly, to an illumination system that comprises a color wheel with a plurality of wave band transforming areas that is capable of automatically adjusting a position of the color wheel.

2. Descriptions of the Related Art

Nowadays, projection devices have been widely used in various situations including business meetings and home theaters. As people's demands on visual experiences have increased, the projection devices must be able to project pictures of different chrominance and brightness levels to satisfy different needs of users.

Among others, conventional projection devices that use lasers as light sources operate under the following principle: fluorescent powders coated on a color wheel are excited by laser rays to generate a red, blue, green or yellow light, which is then transformed by an imaging system of the projection device into a projection picture. However, the colored light excited in this way usually can only be transformed into a projection picture of a specific chrominance or a specific brightness level, but cannot be transformed into projection pictures of different chrominance or different brightness levels depending on different needs. To solve this problem, usually the original color wheel must be manually replaced by a new color wheel so that the new color wheel is excited by the laser light to generate a colored light with a different chrominance and a different brightness level from the original color wheel. However, this is both time and labor consuming It is also difficult to dispose the color wheel in precise alignment in front of the light source; moreover, this requires use of at least one additional color wheel module in the illumination system, which adds to the production cost of the projection device.

Accordingly, an urgent need exists in the art to provide an illumination system that can automatically generate colored lights of different chrominance and different brightness levels depending on practical needs to effectively adjust the chrominance and the brightness of the picture projected by the projection device and that can simplify the structure of the projection device to eliminate the complex adjusting procedure.

### SUMMARY OF THE INVENTION

To solve the aforesaid problem, an objective of the present invention is to provide an illumination system for a projection device. The illumination system can automatically adjust a position of a color wheel thereof so that a light beam projected by a light emitting element onto the color wheel can be selectively transformed into the colored light of different chrominances and different brightness levels. Thereby, the chrominance and the brightness of the projection picture projected by the projection device can be adjusted depending on practical needs.

To achieve the aforesaid objective, the illumination system for a projection device of the present invention comprises a light emitting element, a color wheel and at least one actuator. The light emitting element is adapted to provide a first wave band light. The color wheel has a wheel disk, a plurality of wave band transforming areas and a rotary shaft disposed at a center of the wheel disk. The wave band transforming areas are formed on the wheel disk, and the wheel disk is adapted to rotate about the rotary shaft. The at least one actuator is connected with the color wheel to move the color wheel to a selected position so that the first wave band light is projected to one of the wave band transforming areas to excite a plurality of selected wave band lights. By adjusting the selected position of the color wheel, the first wave band light can be projected onto different wave band transforming areas depending on practical needs to generate a plurality of colored lights of different chrominance and different brightness levels. Thereby, a plurality of color scenario modes can be provided for the users' choice.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view illustrating projection of a first wave band light on a first wave band transforming area in an illumination system according to an embodiment of the present invention;

FIG. 1B is a schematic view illustrating projection of a second wave band light on a second wave band transforming area in an illumination system according to an embodiment of the present invention;

FIG. 2 is a schematic front view of a color wheel of an illumination system according to an embodiment of the present invention;

FIG. 3A is a schematic view illustrating relative position relationships between a color wheel and a light emitting element in an illumination system according to an embodiment of the present invention; and

FIG. 3B is a schematic view illustrating relative position relationships between a color wheel and a light emitting element in an illumination system according to another embodiment of the present invention.

### DESCRIPTION OF THE PREFERRED EMBODIMENT

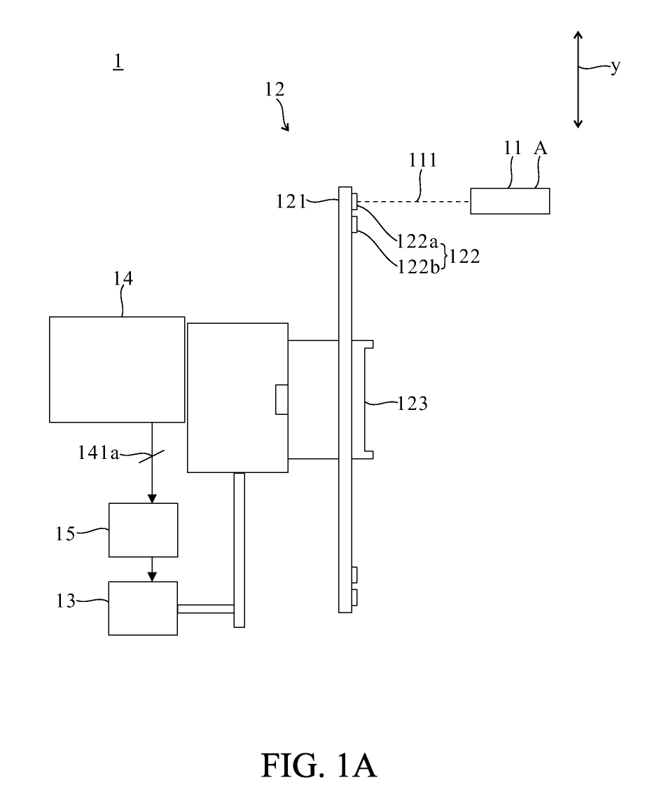

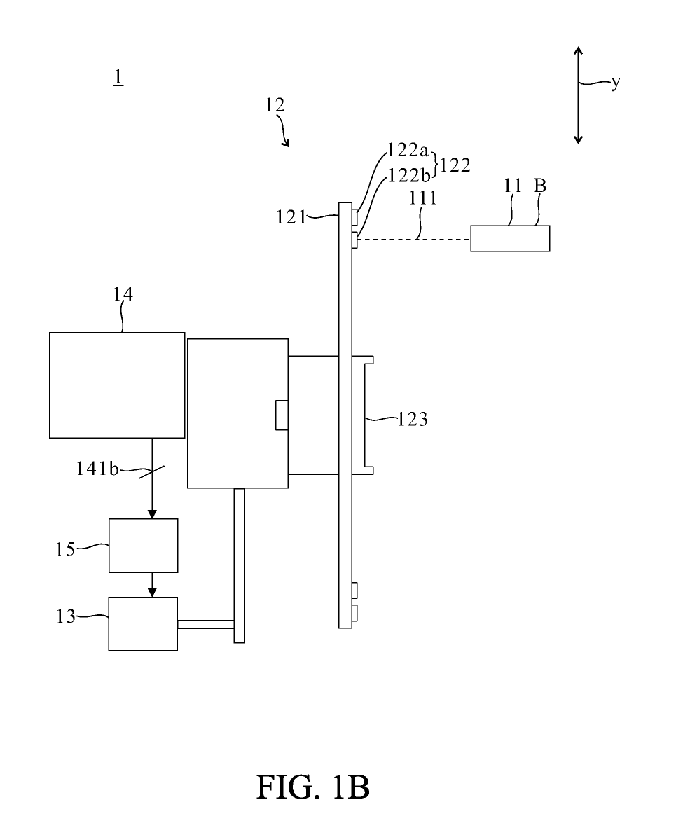

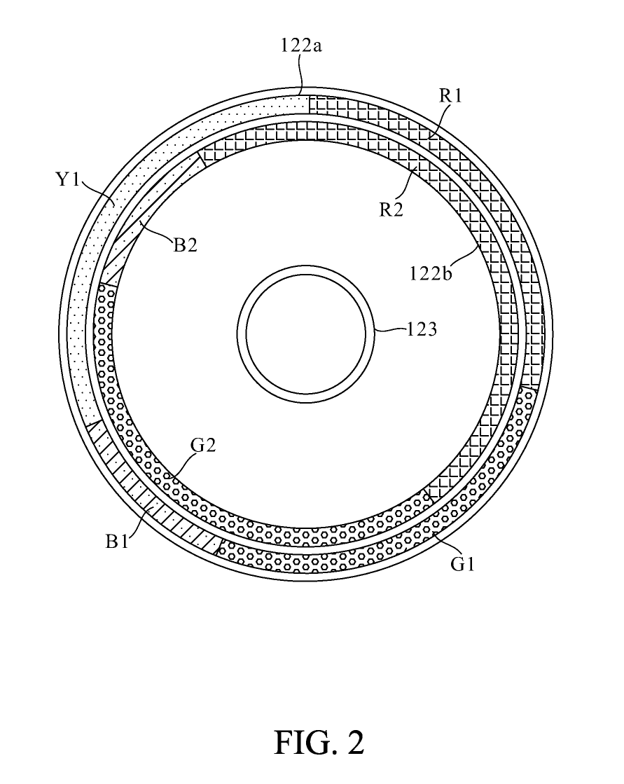

FIG. 1A illustrates a schematic view of an illumination system 1 for a projection device according to the present invention. The illumination system 1 comprises a light emitting element 11, a color wheel 12 and at least one actuator 13. In this embodiment, the light emitting element 11 is a laser diode adapted to generate a first wave band light 111. Also, with reference to FIG. 2, in which a schematic front view of the color wheel 12 is illustrated, the color wheel 12 comprises a wheel disk 121, a plurality of wave band transforming areas 122 and a rotary shaft 123 disposed at a center of the wheel disk 121. The wave band transforming areas 122 are formed on the wheel disk 121 and, in this embodiment, may be formed by coating a plurality of fluorescent materials on the wheel disk 121. The wheel disk 121 is adapted to rotate about the rotary shaft 123. The at least one actuator 13 is connected with the color wheel 12 to move the color wheel 12 to a selected position in a direction y so that the first wave band light 111 is projected to one of the wave band transforming areas 122 to excite a plurality of selected wave band lights. The projection device comprises an imaging module for transforming the selected wave band lights into a projection picture (not shown).

It shall be appreciated that the at least one actuator of the illumination system of the present invention can be manually or electrically driven to adjust the selected position of the color wheel. Hereinbelow, only electrically driving the at least one actuator to adjust the selected position of the color wheel will be illustrated in this embodiment of the present invention.

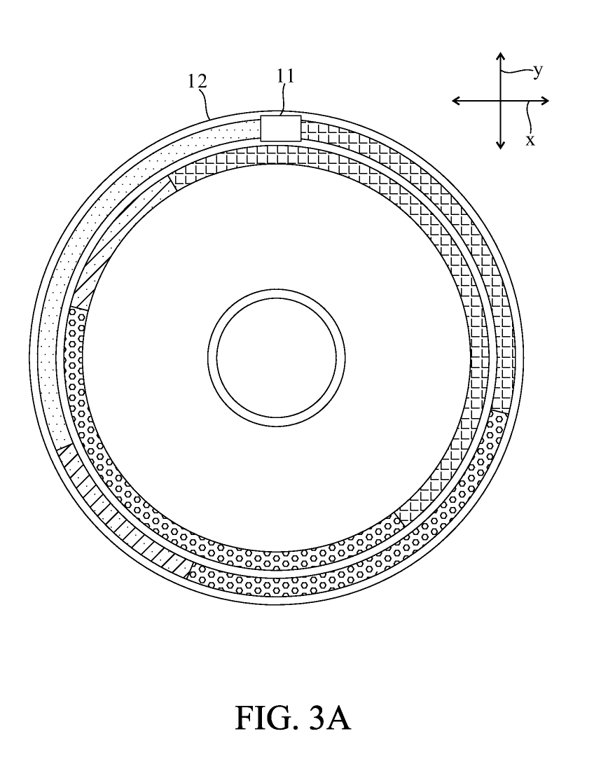

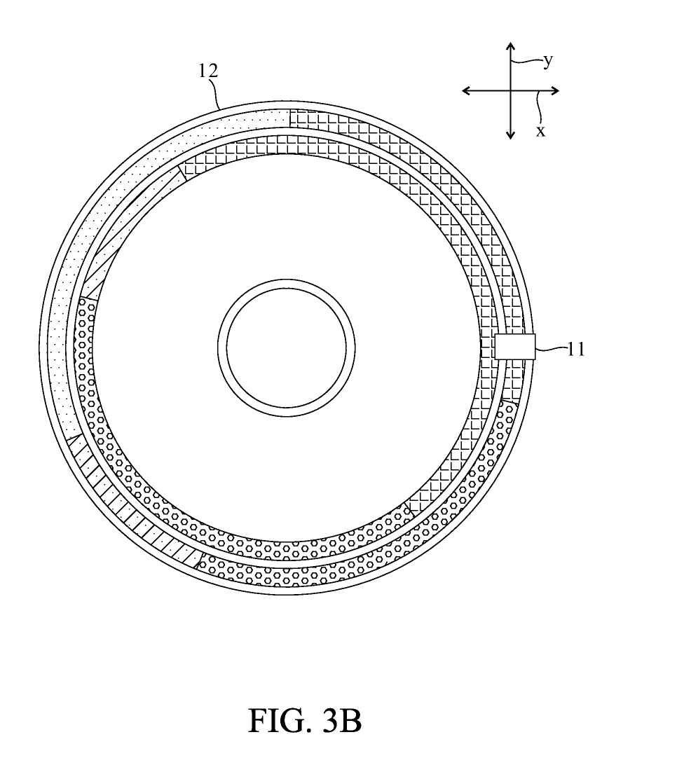

With reference back to FIG. 1, the illumination system 1 comprises a storage module 14 and a control module 15 electrically connected with each other. The storage module 14 may have a plurality of scenario mode signals stored therein. The control module 15 is connected to the at least one actuator 13. The control module 15 is adapted to, according to one of the scenario mode signals, drive the at least one actuator 13 to move the color wheel 12 to the selected position in the y direction so that the light 111 is projected onto one of the wave band transforming areas 122. In this embodiment, the direction y is in a vertical direction. FIG. 3A illustrates a schematic view of relative positional relationships between the color wheel 12 and the light emitting element 11. The light emitting element 11 is disposed at a position near a top portion of the color wheel 12, and the at least one actuator 13 can drive the light emitting element 11 to move in a vertical direction so that the first wave band light 111 is projected onto one of the wave band transforming areas 122.

However, as shown in FIG. 3B, the color wheel 12 may also be moved in a horizontal direction x in other embodiments of the present invention; that is, the light emitting element 11 may be disposed near a side of the color wheel 12. The at least one actuator 13 drives the light emitting element 11 to move in the horizontal direction x. However, the color wheel 12 is not limited to movement in the vertical direction or in the horizontal direction, but may also be moved in any other direction that allows the first wave band light 111 to be projected onto one of the wave band transforming areas 122.

Now, the structure of the color wheel 12 will be detailed. As shown in FIG. 2, the wave band transforming areas 122 of the color wheel 12 include a first wave band transforming area 122a and a second wave band transforming area 122b. The first wave band transforming area 122a is formed at a periphery of the color wheel 121, while the second wave band transforming area 122b is formed between the rotary shaft 123 and the first wave band transforming area 122a. In this embodiment, the first wave band transforming area 122a has a first red fluorescent area R1, a first blue fluorescent area B1, a first green fluorescent area G1 and a first yellow fluorescent area Y1; while the second wave band transforming area 122b has a second red fluorescent area R2, a second green fluorescent area G2 and a second blue fluorescent area B2. In other embodiments of the present invention, the fluorescent areas of the wave band transforming areas 122 may be altered depending on practical needs, and the present invention has no limitation thereon; for example, the yellow fluorescent area Y1 of the first wave band transforming area 122a may also be replaced by a white fluorescent area. As the wheel disk 121 rotates about the rotary shaft 123, the first wave band light 111 can be projected onto the individual fluorescent areas of the wave band transforming areas 122 to excite lights of different wave bands respectively. The wave band lights generated when the first wave band light 111 is projected onto the first wave band transforming area 122a and the second wave band transforming area 122b with different chrominance and different brightness levels. Thus, projection pictures of different chrominance and different brightness levels can be generated by the imaging module of the projection device. The operations of this embodiment will be detailed as follows.

More specifically, in the illumination system 1 of the present invention, a plurality of scenario modes may be predefined to represent a plurality of color scenarios, and a plurality of corresponding scenario mode signals are predefined and stored in the storage module. For example, two scenario modes are predefined in this embodiment: a high chrominance scenario mode and a high brightness scenario mode. A first scenario mode signal 141a and a second scenario mode signal 141b are predefined corresponding to the two scenario modes respectively. In this embodiment, the first scenario mode signal 141a may be set as a high chrominance scenario mode signal, while the second scenario mode signal 141b may be set as a high brightness scenario mode signal. With reference to FIG. 1A, when receiving the first scenario mode signal 141a, the control module 15 drives the at least one actuator 13 to move the color wheel 12 to a first selected position A in the direction y so that the first wave band light 111 is projected onto the first wave band transforming area 122a to excite a plurality of first selected wave band lights. In other words, in the first scenario mode, the wave band lights described above are the first selected wave band lights that are different from the first wave band light.

With reference to FIG. 1B, when receiving the second scenario mode signal 141b, the control module 15 drives the at least one actuator 13 to move the color wheel 12 to a second position B in the y direction so that the exciting light 111 is projected onto the second wave band transforming area 122b to excite a plurality of second selected wave band lights. In other words, in the second scenario mode, the wave band lights described above are the second selected wave band lights that are different from the first wave band lights.

By adjusting the chrominance and brightness levels of the fluorescent areas of the first wave band transforming area 122a and the second wave band transforming area 122b, the chrominance of the first selected wave band lights can be controlled to be higher than that of the second selected wave band lights so that a projection picture with a high chrominance is formed by the first selected wave band lights. The brightness of the second selected wave band lights can be controlled to be higher than that of the first selected wave band lights so that a projection picture with a high brightness can be formed by the second selected wave band lights. Furthermore, because the first wave band transforming area 122a can be excited by the exciting light 111 to emit a colored light with a high chrominance, the temperature generated therein is higher than that in the second wave band transforming area 122b.

Therefore, disposing the first wave band transforming area 122a at the periphery of the color wheel 12 facilitates rapid dissipation of the heat energy to prevent overheating of the wheel disk 121.

Apart from disposing the first wave band transforming area 122a and the second wave band transforming area 122b to provide colored lights of different chrominance and different brightness levels, other different wave band transforming areas may also be additionally formed on the color wheel in other embodiments of the present invention. For example, a third wave band transforming area (not shown) may be additionally disposed between the second wave band transforming area 122b and the rotary shaft 123, and is adjusted to generate wave band lights with a chrominance and a brightness different from those of the wave band lights generated by the first wave band transforming area 122a and the second wave band transforming area 122b. Furthermore, a third scenario mode signal may be further defined so that the excited light is projected onto the third wave band transforming area when the at least one actuator 13 moves the color wheel 12 to a third selected position according to the third scenario mode signal. This will be readily appreciated by those skilled in the art, and thus, will not be further described herein.

It shall be appreciated that the shapes and sizes of the individual elements of the illumination system of the present invention as well as the relative position relationships among the at least one actuator 13, the storage module 14 and the control module 15 are only depicted for ease of understanding but not to limit the actual structures, ratios and positions thereof. The purpose of controlling the color wheel 12 to move and excited different colored lights can be achieved as long as the at least one actuator 13 can be manually or electrically driven to move the color wheel 12 to a selected position so that the first wave band light 111 of the light emitting element 11 is projected to one of the wave band transforming areas 122 of the color wheel 12.

According to the above descriptions, as compared to illumination systems for the conventional projection devices that change the chrominance and the brightness by replacing a color wheel, the illumination system for a projection device of the present invention has only a single color wheel comprising a plurality of wave band transforming areas. By adjusting the position of the single color wheel, the band transforming areas image the light from the light emitting element into projection pictures of different chrominance and different brightness levels; this enhances the color variability of the pictures projected by the projection device, and eliminates the unnecessary elements and replacement procedures, thus, lowering the production cost of the projection device.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An illumination system for a projection device, comprising:
a light emitting element, providing a first wave band light;
a color wheel, the color wheel having a wheel disk, a plurality of wave band transforming areas and a rotary shaft, the rotary shaft being disposed at a center of the wheel disk, the wave band transforming areas being formed on the wheel disk, and the wheel disk rotating about the rotary shaft; and
an actuator, connecting with the color wheel to move the color wheel to a selected position so that the first wave band light is projected to one of the wave band transforming areas to excite a plurality of selected wave band lights which are different from the first wave band light.

2. The illumination system as claimed in claim 1, wherein the wave band transforming areas include a first wave band transforming area formed on a periphery of the wheel disk, and the actuator is adapted to drive the color wheel to move to a first selected position so that the first wave band light is projected to the first wave band transforming area to excite a plurality of first selected wave band lights.

3. The illumination system as claimed in claim 2, wherein the wave band transforming areas include a second wave band transforming area formed between the rotary shaft and the first wave band transforming area, and the actuator is adapted to drive the color wheel to a second selected position so that the first wave band light is projected to the second wave band transforming area to excite a plurality of second selected wave band lights.

4. The illumination system as claimed in claim 3, wherein a chrominance of each of the first selected wave band lights is higher than a chrominance of each of the second selected wave band lights.

5. The illumination system as claimed in claim 4, wherein a brightness of each of the second selected wave band lights is higher than a brightness of each of the first selected wave band lights.

6. The illumination system as claimed in claim 5, wherein the wave band transforming areas are formed by coating a plurality of fluorescent materials on the wheel disk.

7. The illumination system as claimed in claim 6, wherein the first wave band light is a laser diode.

8. The illumination system as claimed in claim 7, wherein the first wave band transforming area has a first red fluorescent area, a first blue fluorescent area, a first green fluorescent area and a first yellow fluorescent area.

9. The illumination system as claimed in claim 7, wherein the first wave band transforming area has a first red fluorescent area, a first blue fluorescent area, a first green fluorescent area and a first white fluorescent area.

10. The illumination system as claimed in claim 7, wherein the second wave band transforming area has a second red fluorescent area, a second green fluorescent area and a second blue fluorescent area.

11. The illumination system as claimed in claim 7, wherein the illumination system comprises a storage module and a control module electrically connected to each other, the storage module stores a plurality of scenario mode signals, the control module is electrically connected to the actuator, and the control module is adapted to drive the actuator to move the color wheel to the selected position according to one of the scenario mode signals so that the first wave band light is projected to one of the wave band transforming areas to excite the selected wave band lights which are different from the first wave band light.

12. The illumination system as claimed in claim 11, wherein the scenario mode signals include a first scenario mode signal, and when receiving the first scenario mode signal, the control module drives the actuator to move the color wheel to the first selected position so that the first wave band light is projected to the first wave band transforming area to excite the first selected wave band lights.

13. The illumination system as claimed in claim 12, wherein the scenario mode signals include a second scenario mode signal, and when receiving the second scenario mode signal, the control module drives the actuator to move the color wheel to the second selected position so that the first wave band light is projected to the second wave band transforming area to excite the second selected wave band lights.

14. The illumination system as claimed in claim 7, wherein the actuator is driven manually to move the color wheel to the selected position so that the first wave band light is projected to one of the wave band transforming areas to excite the selected wave band lights which are different from the first wave band light.

15. The illumination system as claimed in claim 1, wherein the projecting device comprises an imaging module for transforming the selected wave band lights into a projection picture.
